(19) United States
(12) Patent Application Publication
(10) Pub. No.: US 2024/0103897 A1
(43) Pub. Date: Mar. 28, 2024

(54) DIVERSIFIED VIRTUAL MEMORY

(71) Applicants: Advanced Micro Devices, Inc., Santa Clara, CA (US); ATI Technologies ULC, Markham (CA)

(72) Inventors: Norman Vernon Douglas Stewart, Markham (CA); Mihir Shaileshbhai Doctor, Santa Clara, CA (US); Omar Fakhri Ahmed, Markham (CA)

(73) Assignees: Advanced Micro Devices, Inc., Santa Clara, CA (US); ATI Technologies ULC, Markham (CA)

(21) Appl. No.: 17/954,183

(22) Filed: Sep. 27, 2022

(51) Int. Cl. G06F 9/455; G06F 3/06; G06F 12/02

(52) U.S. Cl. CPC G06F 9/45558; G06F 3/0613; G06F 3/0659; G06F 3/0665; G06F 3/0683; G06F 12/0292; G06F 2009/45583; G06F 2212/657

(57) ABSTRACT

Systems and methods are disclosed for managing diversified virtual memory by an engine. Techniques disclosed include receiving one or more request messages, each request message including a job descriptor that specifies an operation to be performed on a respective virtual memory space, processing the job descriptors by generating one or more commands for transmission to one or more virtual memory managers, and transmitting the one or more commands to the one or more virtual memory managers (VMMs) for processing.

### BACKGROUND

A memory management module, employed by an operating system of a computing system, provides applications with a contiguous memory space, namely, a virtual memory space. The physical memory storage that supports the virtual memory space can be provided by various memory devices, either internal to the computing system (e.g., main memory) or external to it (e.g., hard disk). The memory management model is designed to facilitate efficient utilization of the available virtual memory space, carrying out operations such as allocation of memory blocks for applications or migration of memory blocks to reduce fragmentation.

To gain access to the physical memory, the memory management module translates (or maps) virtual addresses to physical addresses. This task is complicated by the need to use different interface protocols with respect to different memory devices. Furthermore, the memory management module (being software based) is limited to sequential execution of the operations it carries out. Techniques are needed to accelerate these operations, especially when various virtual memory interface protocols are involved.

### BRIEF DESCRIPTION OF THE DRAWINGS

A more detailed understanding may be had from the following description, given by way of example in conjunction with the accompanying drawings wherein:

FIG. 1 is a block diagram of an example device, based on which one or more features of the disclosure can be implemented;

FIG. 2 is a block diagram that illustrates the operation of an example diversified virtual memory (DVM) engine, based on which one or more features of the disclosure can be implemented;

FIG. 3 is a block diagram of an example DVM engine, based on which one or more features of the disclosure can be implemented; and

FIG. 4 is a flowchart of an example method for managing diversified virtual memory, based on which one or more features of the disclosure can be implemented.

### DETAILED DESCRIPTION

Systems and methods are provided for efficient management of diversified virtual memory by a diversified virtual memory (DVM) engine (also referred to herein as an engine). On behalf of a memory manager of an operating system (OS), the DVM engine engages with various memory devices—including distributing commands to perform operations (requested by the memory manager) to the appropriate memory devices, in accordance with interface protocols required by the virtual memory managers (VMM) of the respective memory devices. The DVM engine's circuitries are configured to distribute the commands in an order that is in accordance with the respective priority levels of the commands, and to combine commands that can be parallelized.

Systems and methods are disclosed for managing diversified virtual memory by an engine. Techniques disclosed include receiving one or more request messages, each request message including a job descriptor that specifies an operation to be performed on a respective virtual memory space, processing the job descriptors by generating one or more commands for transmission to one or more virtual memory managers, and transmitting the one or more commands to the one or more virtual memory managers (VMMs) for processing.

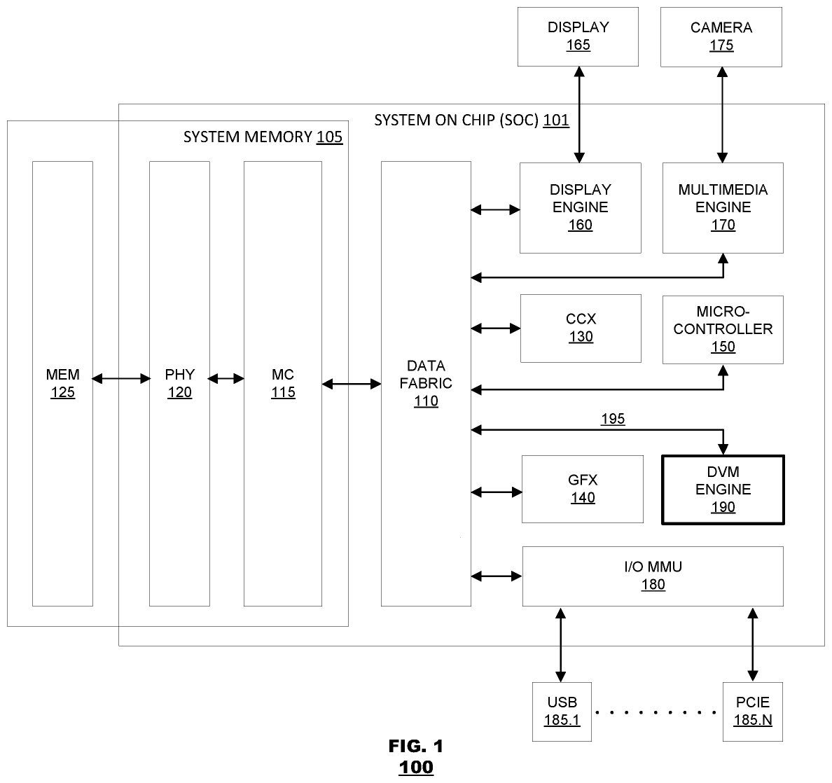

FIG. 1 is a block diagram of an example device 100, based on which one or more features of the disclosure can be implemented.

The device 100 contains a SoC 101, including system components such as central processing units or cores (sometimes “processor” or “processors”), denoted as a core complex (CCX) 130 in FIG. 1, graphical processing units (sometimes “GPU” or “GPUs”), denoted as GFX 140, a microcontroller 150, a display engine 160, a multimedia engine 170, an input/output (I/O) memory management unit (MMU) 180, DVM engine 190, and other SoC components (not shown).

The processor 130, controlled by an operating system (OS) executed thereon, is configured to run applications and drivers. The GPU 140 can be employed by those applications (via the drivers) to execute computational tasks, typically involving parallel computing on multidimensional data (e.g., graphical rendering and/or processing of image data). The microcontroller 150 is configured to perform system level operations—such as assessing system performance based on performance hardware counters, tracking the temperature of components of the SoC 101, and processing information from the OS. Based on data the microcontroller 150 gathers, for example, the microcontroller 150 manages the power allocation to the different components of the SoC.

As disclosed herein, the DVM engine 190 includes circuitries that are designed to provide efficient access to different types of physical memory units, for example, units that are part of the main memory and cache systems of various SoC components.

The SoC 101 further includes a data fabric 110, a memory controller (MC) 115, and a physical layer (PHY) 120 that provide access to memory (MEM) 125, e.g., consisting of DRAM units. The data fabric 110 is typically implemented by a network of switches that interconnect the SoC components 130, 140, 150, 160, 170, 180, 190 to each other and also provides the SoC components with read and write access to memory 125. The memory controller 115, the physical layer 120, and the memory 125 can be considered as parts of a system memory 105, and may each include multiple units of memory controllers, physical layers, and memory units, respectively, that may be connected to respective multiple units of data fabrics of the data fabric 110.

The device 100 of FIG. 1 can be a mobile computing device, such as a laptop. In such a case, I/O ports 185.1-N (or collectively 185) of the device—including, for example, a universal serial bus (USB) port 185.1 and a peripheral component interconnect express (PCIE) port 185.N, among other I/O ports—can be serviced by the I/O MMU 180 of the SoC 101.

The display 165 of the device can be connected to the display engine 160 of the SoC 101. The display engine 160 can be configured to provide the display 165 with rendered content (e.g., generated by the GPU 140) or to capture content presented on the display 165 (e.g., to be stored in memory 125 or to be delivered by the I/O MMU 180 via one of the I/O ports 185 to a destination device or server). The camera 175 of the device can be connected to the multimedia engine 170. The multimedia engine 170 can be configured to process video captured by the camera 175, including encoding the captured video (e.g., to be stored in memory 125 or to be delivered by the I/O MMU 180 via one of the I/O ports 185 to a destination device or server).

Generally, memory management is implemented by a software module employed by the OS that runs on the processor 130. The software module performs, inter alia, translations of virtual memory addresses to physical memory addresses. Such translations depend on a device-specific protocol, that is, the interface protocol that is required by a virtual memory manager (VMM) of a physical memory device that a virtual memory address is mapped into. In other words, the manner in which virtual memory addresses are translated to physical memory addresses depends on the specific device in which the targeted physical memory exists.

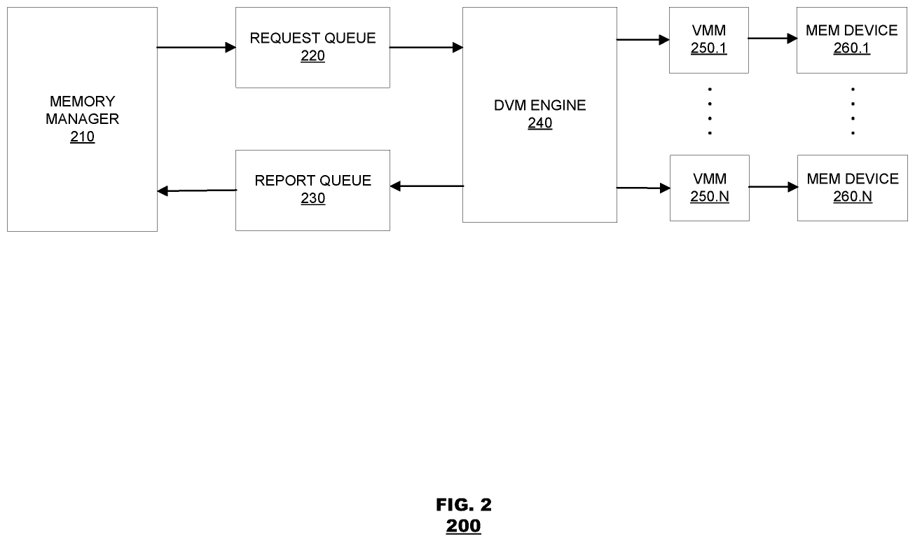

A DVM engine 190, as disclosed herein, is configured to perform translations of virtual memory addresses into physical memory addresses using respective device-specific protocols. Thus, rather than have the OS directly and discretely manage memory spaces of different target memory devices, a DVM engine can be configured to take over such functionality. In such a case, the DVM engine directly interacts with various implementations of virtual memory mappings, according to respective protocols, and accelerates operations that are typically involved in memory management—including data allocation, data deletion, data migration (to resolve fragmented memory), as well as cache invalidation and flushing. A DVM engine (e.g., the DVM engine 190 of FIG. 1) is further described in reference to FIG. 2.

FIG. 2 is a block diagram that illustrates the operation of an example DVM engine 200, based on which one or more features of the disclosure can be implemented. As shown, a DVM engine 240 is configured to receive request messages from a memory manager 210 (e.g., a software model employed by the OS, running on a processor such as the processor 130 of FIG. 1).

The request messages are delivered through a request queue 220, accessible via the data fabric 110. The request messages include job descriptors that specify operations that involve accessing one or more memory spaces of various target devices. The DVM engine 240 manages and processes the job descriptors. Upon completion of a job descriptor, the DVM engine reports back to the memory manager, sending report messages through a report queue 230, informing the memory manager 210 that operations specified in respective job descriptors have been performed.

In processing a job descriptor, the DVM engine 240 generates one or more commands that facilitate access to a memory device to perform the operations specified in the job descriptor. To that end, the DVM engine 240 is configured to interact with virtual memory managers (VMM) 250.1-N (collectively, 250) of respective physical memory devices 260.1-260.N (collectively, 260) according to their respective device-specific protocols. A virtual memory manager 250 receives commands from the DVM engine 240 and processes those commands to access memory of respective physical memory devices 260 according to the commands.

In this manner, the DVM abstracts the task of interacting with various VMMs 250 (that access different virtual spaces) according to their respective protocols relative to the memory manager 210. For example, to perform an operation with respect to a memory segment starting at a specific virtual address, the memory manager 210 sends a request message via the request queue 220, containing a job descriptor that specifies the memory segment size, a starting virtual memory address, the operation required, and any other relevant information (e.g., priority of the request).

In an aspect, the DVM engine implements one or more virtual memory interface protocols of VMMs 250 associated with the main memory or the cache memory of SoC components such as the processor 130, the GPU 140, and the I/O MMU 180. Hence, the DVM engine includes circuitries, that may be programed by software, firmware, or hardware (state machines), to generate commands according to device-specific protocols, to pack the commands into packets, and to transmit the packets to a respective VMM 250 that in turn is designed to access the physical memory of the respective memory device 260 to perform the commands. More specifically, a VMM 250 has hardware, software, or a combination thereof, that receives commands to access memory, using physical addresses, and performs those commands for a corresponding hardware unit. Different VMMs 250 process commands in different formats, and may return data to the DVM engine 240 in different formats and/or according to different techniques.

While a software module of the memory manager 210 can only sequentially interact with different VMMs 250, the DVM engine can interact with the VMMs in parallel. To that end, the DVM contains separate execution pipelines that each serves a respective VMM 250.

In addition, within an execution pipeline, commands that can be performed in parallel may be combined into one packet. In an example, an execution pipeline generates a single packet that includes multiple commands for execution by a VMM 250 in parallel. Commands that have to be performed one after the other (sequentially) are packed in separate packets. The parallelism afforded by the DVM engine 240 results in performance improvement as compared with a system that does not include the DVM engine 240.

In an aspect, the DVM engine 240 operates in response to request messages sent to the DVM engine 240 by the memory manager 210 through the request queue 220. For example, on behalf of an application, requiring the allocation of a memory segment or the deletion of a memory segment, the memory manager may push a request message into the request queue with the appropriate job descriptor. The DVM engine 240 then processes such request message, translating specified virtual memory addresses and generating commands and packets for processing by an appropriate VMM 250.

In some examples, the memory manager 210 also initiates operations (such as moving data segments from one virtual memory range to another to reduce fragmentation of the memory space) and accordingly pushes request messages into the request queue 220 with the appropriate job descriptors. Thus, the memory manager 210, in carrying out its memory management strategy, has only to refer to virtual memory addresses, while the DVM engine is in charge of translating those addresses into the physical addresses and commands in accordance with the interface protocols of the VMMs 250 of the respective target memory devices 260. In this way, the DVM engine accelerates the operation of the memory manager 210. For example, operations required by the memory manager 210 that involve accessing the cache memory (which is or is included in, in some examples, a memory device 260) may also be accelerated by the DVM engine.

Specifically, generally, a cache controller has a specific interface protocol through which data segments in the cache can be invalidated or cleared (flushed). And so, invalidating a data segment in the cache may be accomplished by a series of commands to that cache controller (including the writing of an address to a register and the writing of an invalidation command to another register).

Using the DVM engine 240, a single job descriptor can be sent to the DVM engine 240 that requests, for example, to invalidate a 1 Mbyte segment starting at a certain address. In turn, the DVM engine translates that job descriptor into the series of commands that are needed to invalidate that contiguous range of memory in the cache and forward these commands to the cache controller.

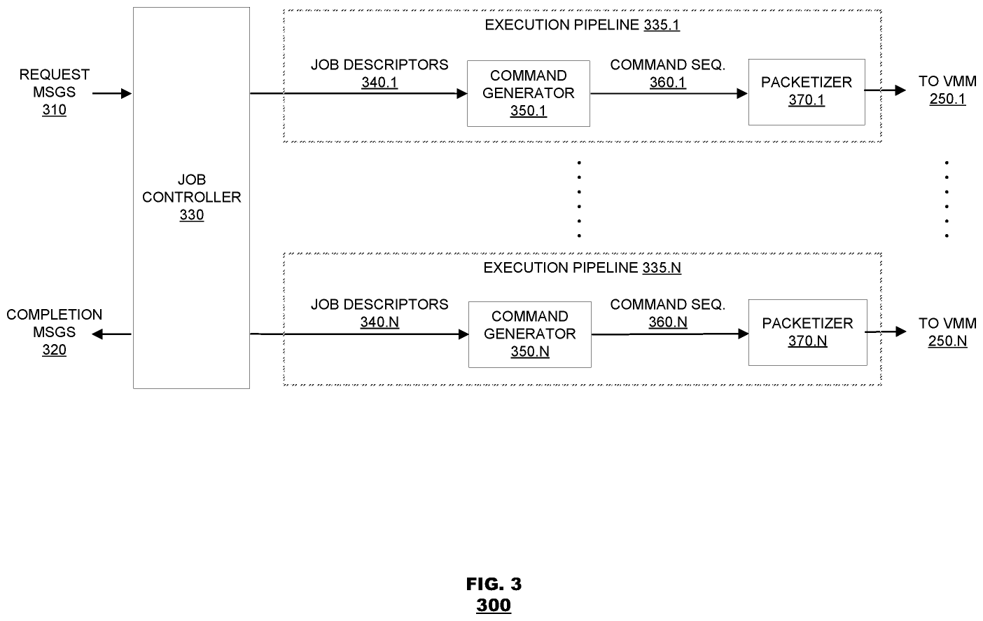

FIG. 3 is a block diagram of an example DVM engine 300, based on which one or more features of the disclosure can be implemented.

FIG. 3 provides further detail with respect to the operation of the DVM engine 240 of FIG. 2. The DVM engine 300 includes a job controller 330 that tracks the performance of jobs specified in job descriptors contained in incoming request messages 310. Based on analyses of the job descriptors, the job controller distributes these descriptors into execution pipelines 335.1-N (collectively 335). Each execution pipeline (e.g., 335.1) includes a command generator (e.g., 350.1) and a packetizer (e.g., 370.1).

As mentioned above, request messages 310, accumulated in the request queue 220, are serviced by the DVM engine 300. The job controller 330 extracts job descriptors from those request messages 310. A job descriptor includes information with respect to one or more operations that are requested to be performed (e.g., allocation, migration, deletion, or invalidation) on a target data segment. The target data segment is specified based on the virtual address it begins at and the data segment's size.

Based on the information in each extracted job descriptor, the job controller 330 processes the job descriptor. The job controller, based on the virtual location of the target data segment, transfers the job descriptor into the proper execution pipeline 335—that is, the pipeline that feeds the VMM 250 of the memory device 260 that provides the physical storage for that target segment.

In an execution pipeline (e.g., 335.1), job descriptors (e.g., 340.1) are processed by a command generator (e.g., 350.1). The command generator 350 translates a given job descriptor into a sequence of commands according to an interface protocol (e.g., the interface protocol that is required by an associated VMM). A packetizer (e.g., 370.1) then packs the generated command sequence into packets to be delivered to the respective VMM (e.g., 250.1). In an aspect, the command generator 350 determines whether all or part of the commands in the sequence can be performed (by the receiving VMM) in parallel. If so, in some implementations, the packetizer packs commands that can be performed in parallel together into a single packet.

Upon completion of commands associated with a job descriptor, the respective VMM 250 notifies the job controller 330 via a feedback mechanism (not shown). The job controller 330 can then report back to the memory manager 210 (of FIG. 2) by pushing a completion message 320 into the report queue 230.

Additionally, the job controller 330, based on information in jobs descriptors (in incoming request messages 310), may prioritize the service of these jobs, and so distribute the job descriptors 340 to the appropriate execution pipeline(s) 335 in an order that is according to their respective priorities. In an example, a first job descriptor has a higher priority than a second job descriptor. In response to this set of priorities, the job controller 330 prioritizes service of the higher priority job descriptor over the lower priority job descriptor. In an example, prioritizing the higher priority job descriptor includes transmitting that job descriptor to an execution pipeline 335 before transmitting the lower priority job descriptor to an execution pipeline 335. In some examples, priority is communicated explicitly, and the relative order with which the job descriptors are transmitted to the execution pipeline 335 in any order. The execution pipelines 335 enforce the priority explicitly transmitted by performing a higher priority job descriptor earlier than a lower priority job descriptor.

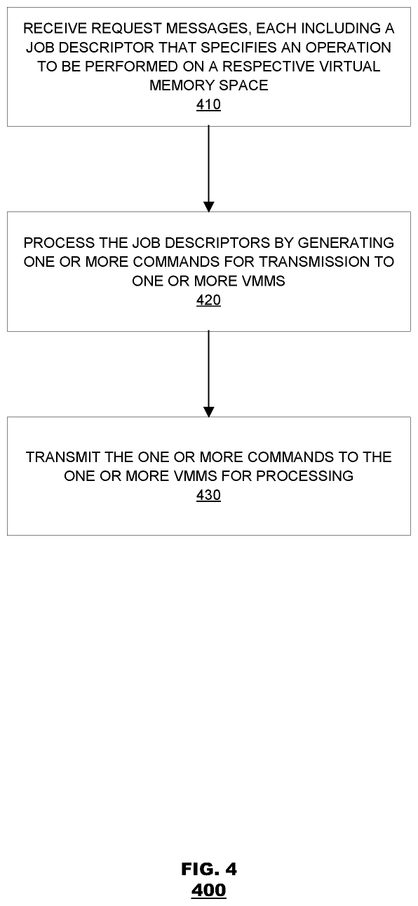

FIG. 4 is a flowchart of an example method 400 for managing diversified virtual memory, based on which one or more features of the disclosure can be implemented. Although described with respect to the system of FIGS. 1-3, those of skill in the art will understand that any system, configured to perform the steps of the method 400 in any technically feasible order, falls within the scope of the present disclosure.

The method 400 begins, in step 410, by receiving request messages (e.g., received from the memory manager 210 deployed by the OS of the processor 130 of FIG. 1). Each request message includes a job descriptor that specifies an operation to be performed on a respective virtual memory address range (e.g., a data segment that is defined by a starting address and a segment size). An operation specified by a job descriptor may be allocation, deletion, or migration of memory data within the respective virtual memory space; or invalidation or clearing of cache data within the respective virtual memory space. Although some example operations are described, operations other than what has been described are possible.

In step 420, the DVM engine 240 processes the job descriptors by generating one or more commands based on the job descriptors to be transmitted to one or more respective VMMs. In some examples, step 420 is performed in the following manner. The job descriptors in the received request messages are distributed into execution pipelines 335 of the DVM engine 240. Each of the execution pipelines feeds a VMM 250 of a memory device 260. For example, a job descriptor can be directed into an execution pipeline by first mapping the respective virtual memory space to a physical memory space, and then, selecting an execution pipeline that feeds a respective VMM of a memory device that provides that physical memory space. In an aspect, the distribution of job descriptors to execution pipelines can be done in an order that is according to priority values associated with the job descriptors.

In some examples, processing the job descriptors further includes processing the distributed job descriptors in the respective execution pipelines 335. A job descriptor that was directed to an execution pipeline may be processed by generating, based on information in the job descriptor, a command sequence. The command sequence is generated according to an interface protocol of a VMM corresponding to that execution pipeline.

The method 400 proceeds, in step 430, by transmitting the generated commands to the one or more VMMs. In some implementations, step 430 is performed in the following manner. The generated command sequence is packed into packets, where commands that can be performed in parallel are combined into one packet (or fewer packets than the number of the commands). In some implementations, commands generated by a particular execution pipeline (e.g., 335.1) are sent to the VMM corresponding to that execution pipeline (e.g., 250.1).

In some examples, in response to a feedback received from the respective VMM, indicating completion of the performance of commands in the sent packets, the DVM engine 240 sends a completion message 320, indicating completion of the operation, specified in the job descriptor, to the original requestor (i.e., the unit that generated the job descriptor, such as the memory manager 210).

It should be understood that many variations are possible based on the disclosure herein. Although features and elements are described above in particular combinations, each feature or element can be used alone without the other features and elements or in various combinations with or without other features and elements.

The methods provided can be implemented by SoC components (of FIG. 1) in a general-purpose computer, a processor, or a processor core. Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such as instructions capable of being stored on a computer readable media). The results of such processing can be mask works that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general-purpose computer or a processor or hardware finite state machines. Examples of a non-transitory computer-readable medium include read only memory (ROM), random-access memory (RAM), a register, cache memory, semiconductor memory devices, magnetic media such as internal hard disks and removable disks, magneto-optical media, and optical media such as CD-ROM disks, and digital versatile disks (DVDs). The various functional units of the figures are implemented, where appropriate, as software, hardware (e.g., circuitry), or a combination thereof.

What is claimed is:

1. A method for managing diversified virtual memory, the method comprising:
receiving one or more request messages, each request message including a job descriptor that specifies an operation to be performed on a respective virtual memory space;
processing the job descriptors by generating one or more commands for transmission to one or more virtual memory managers; and
transmitting the one or more commands to the one or more virtual memory managers (VMMs) for processing.

2. The method of claim 1, wherein the processing comprises:
for each of the job descriptors:
mapping the respective virtual memory space to a physical memory space; and
selecting an execution pipeline, that feeds a respective VMM of a memory device corresponding to the physical memory space.

3. The method of claim 1, wherein the processing comprises:
distributing the job descriptors to execution pipelines in an order that is according to priority values associated with the job descriptors.

4. The method of claim 1, wherein the processing comprises:
processing the job descriptor in an execution pipeline by generating a command sequence according to an interface protocol of a VMM associated with the execution pipeline.

5. The method of claim 4, wherein the transmitting further comprises:
packing the one or more commands into packets, wherein commands that can be performed in parallel are combined into one packet.

6. The method of claim 5, wherein the transmitting further comprises:
sending the packets to the VMM associated with the execution pipeline,
receiving feedback from the VMM associated with the execution pipeline, indicating completion of the performance of commands in the sent packets; and
sending a completion message, indicating completion of the operation specified by the job descriptor.

7. A system, including an engine for managing diversified virtual memory, comprising:
circuitry of a job controller, configured to:
receive one or more request messages, each request message including a job descriptor that specifies an operation to be performed on a respective virtual memory space, and
circuitry of an execution pipeline, configured to:
process the job descriptors by generating one or more commands for transmission to one or more virtual memory managers, and
transmit the one or more commands to the one or more virtual memory managers (VMMs) for processing.

8. The system of claim 7, wherein the processing comprises:
for each of the job descriptors:
mapping the respective virtual memory space to a physical memory space; and
selecting an execution pipeline, that feeds a respective VMM of a memory device corresponding to the physical memory space.

9. The system of claim 7, wherein the processing comprises:
distributing the job descriptors to execution pipelines in an order that is according to priority values associated with the job descriptors.

10. The system of claim 7, wherein the processing comprises:
processing the job descriptor in an execution pipeline by generating a command sequence according to an interface protocol of a VMM associated with the execution pipeline.

11. The system of claim 10, wherein the transmitting further comprises:
packing the one or more commands into packets, wherein commands that can be performed in parallel are combined into one packet.

12. The system of claim 11, wherein the transmitting further comprises:
sending the packets to the VMM associated with the execution pipeline,
receiving feedback from the VMM associated with the execution pipeline, indicating completion of the performance of commands in the sent packets; and
sending a completion message, indicating completion of the operation specified by the job descriptor.

13. The system of claim 7, wherein the operation specified by the job descriptor comprises allocation, deletion, migration, or a combination thereof, of memory data within the respective virtual memory space.

14. The system of claim 7, wherein the operation specified by the job descriptor comprises invalidation, clearing, or a combination thereof, of cache data within the respective virtual memory space.

15. A non-transitory computer-readable medium storing instructions that, when executed by a processor, cause the processor to perform operations comprising:
receiving one or more request messages, each request message including a job descriptor that specifies an operation to be performed on a respective virtual memory space;
processing the job descriptors by generating one or more commands for transmission to one or more virtual memory managers; and
transmitting the one or more commands to the one or more virtual memory managers (VMMs) for processing.

16. The non-transitory computer-readable medium of claim 15, wherein the processing comprises:
for each of the job descriptors;
mapping the respective virtual memory space to a physical memory space; and
selecting an execution pipeline, that feeds a respective VMM of a memory device corresponding to the physical memory space.

17. The non-transitory computer-readable medium of claim 15, wherein the processing comprises:
distributing the job descriptors to execution pipelines in an order that is according to priority values associated with the job descriptors.

18. The non-transitory computer-readable medium of claim 15, wherein the processing comprises:
processing the job descriptor in an execution pipeline by generating a command sequence according to an interface protocol of a VMM associated with the execution pipeline.

19. The non-transitory computer-readable medium of claim 18, wherein the transmitting further comprises:
packing the generated command sequence into packets, wherein commands that can be performed in parallel are combined into one packet.

20. The non-transitory computer-readable medium of claim 19, wherein the transmitting further comprises:
sending the packets to the VMM associated with the execution pipeline,
receiving feedback from the VMM associated with the execution pipeline, indicating completion of the performance of commands in the sent packets; and
sending a completion message, indicating completion of the operation specified by the job descriptor.
